(19) United States
(12) Patent Application Publication
(10) Pub. No.: US 2023/0420684 A1
(43) Pub. Date: Dec. 28, 2023

(54) CONDUCTIVE POLYMERS AND ELECTRODE PROCESSING USEFUL FOR LITHIUM BATTERIES

(71) Applicant: THE REGENTS OF THE UNIVERSITY OF CALIFORNIA, Oakland, CA (US)

(72) Inventors: Gao Liu, Piedmont, CA (US); Tianyu Zhu, Columbia, SC (US)

(73) Assignee: THE REGENTS OF THE UNIVERSITY OF CALIFORNIA, Oakland, CA (US)

(21) Appl. No.: 18/347,757

(22) Filed: Jul. 6, 2023

Related U.S. Application Data
(63) Continuation of application No. PCT/US2022/012376, filed on Jan. 13, 2022.
(60) Provisional application No. 63/137,087, filed on Jan. 13, 2021.

(51) Int. Cl. H01M 4/62; H01M 4/13; H01M 4/66; H01M 4/38; H01M 4/134; C08F 220/18; C08F 220/06; C08G 73/02; C08G 61/12; C08G 61/02

(52) U.S. Cl. CPC H01M 4/622; H01M 4/13; H01M 4/661; H01M 4/382; H01M 4/134; C08F 220/1818; C08F 220/1806; C08F 220/06; C08G 73/0266; C08G 61/126; C08G 61/02; H01M 2004/021

(57) ABSTRACT

A conductive polymer that can be formed by removing or separating a side chain, or alkyl or aryl side chain from an unmodified polymer by heating or exposure to light (hv).

### CROSS-REFERENCE TO RELATED PATENT APPLICATIONS

This application claims priority to, and is a 35 U.S.C. § 111(a) continuation of, PCT international application number PCT/US2022/012376 filed on Jan. 13, 2022, incorporated herein by reference in its entirety, which claims priority to, and the benefit of, U.S. provisional patent application Ser. No. 63/137,087 filed on Jan. 13, 2021, incorporated herein by reference in its entirety. Priority is claimed to each of the foregoing applications.

The above-referenced PCT international application was published as PCT International Publication No. WO 2022/225583 A2 on Oct. 27, 2022, which publication is incorporated herein by reference in its entirety.

### STATEMENT OF GOVERNMENTAL SUPPORT

The invention was made with government support under Contract No. DE-AC02-05CH11231 awarded by the U.S. Department of Energy. The government has certain rights in the invention.

### FIELD OF THE INVENTION

The present invention is in the field of lithium ion batteries.

### BACKGROUND OF THE INVENTION

Rechargeable lithium-ion batteries hold great promise as energy storage devices to solve the temporal and geographical mismatch between the supply and demand of electricity, and are therefore critical for many applications such as portable electronics and electric vehicles. Electrodes in these batteries are based on intercalation reactions in which Li+ ions are inserted (extracted) from an open host structure with electron injection (removal). However, the current electrode materials need more limited specific charge storage capacity and cannot achieve the higher energy density, higher power density, and longer lifespan that all these important applications require. Si as an alloying electrode material is attracting much attention because it has the highest known theoretical charge capacity (4200 mA h g⁻).

### SUMMARY OF THE INVENTION

The present invention provides for a conductive polymer having repeating subunits defined by any unmodified polymer having one of the following formulae:

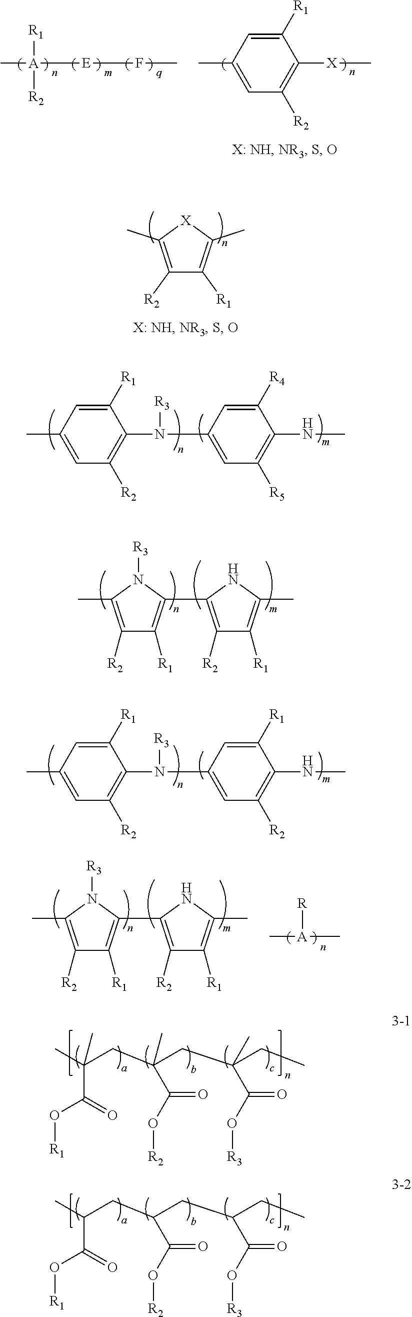

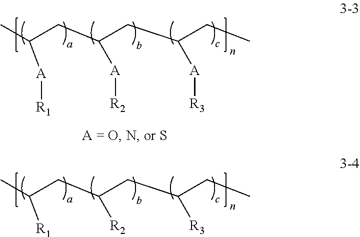

or any unmodified polymer described in U.S. Pat. Nos. 8,852,461; 9,077,039; 9,153,353; 9,722,252; 9,653,734; 10,170,765; and 10,246,781; and U.S. Patent Application Publication No. 2015/0364755; wherein at least one R group, side chain, or alkyl or aryl side chain, of at least one subunit of the unmodified polymer is removed or separated from the unmodified polymer. In some embodiments, the R group, side chain, or alkyl or aryl side chain is removed or separated from the polymer by heating or exposure to light (hv).

The present invention provides for a thin film electrode comprising a first layer comprising the conductive polymer of the present invention on a second layer of current collector comprising an electricity conductive material. In some embodiments, the conductive material is a metal, such as silver, copper, gold, aluminum, iron, steel, brass, bronze, or mercury. In some embodiments, the conductive material is graphite. In some embodiments, the first layer and the second layer completely cover a third layer comprising Li metal, Al, Sn, or Mg, or any material alloy comprising Li metal or Na or Mg. In some embodiments, the third layer is very thin, such as from about 0.1 nm to about 1 nm. In some embodiments, the third layer is thick, such as from about 1 nm to about 1 mm. In some embodiments, the third layer has a thickness of about 0.1 nm, 0.5 nm, 1 nm, 5 nm, 10 nm, 50 nm, 100 nm, 500 nm, 1 μm, 5 μm, 10 μm, 50 μm, 100 μm, 500 μm, or 1 mm, or having a thickness between any two of the preceding values.

The present invention provides for a lithium ion battery having the thin film electrode of the present invention. In some embodiments, the lithium ion battery comprises a negative electrode, wherein said electrode comprises the thin film electrode of the present invention.

The present invention provides for a method for producing a conductive polymer comprising heating, or exposing to light (hv), a polymer (described herein in any of the formulae or described in U.S. Pat. Nos. 8,852,461; 9,077,039; 9,153,353; 9,722,252; 9,653,734; 10,170,765; and, 10,246,781; and, U.S. Patent Application Publication No. 2015/0364755), such that at least one R group of at least one subunit of the polymer is removed or separated from the polymer resulting in the formation of a conductive polymer of the present invention. In some embodiments, the heating step comprises heating a polymer to a temperature of about 200° C., 250° C., 300° C., 350° C., 400° C., 450° C., or 500° C., or a temperature between any two of the preceding values, such that at least one R group of at least one subunit of the polymer is removed or separated from the polymer. In some embodiments, at least about 10%, 20%, 30%, 40%, 50%, 60%, 70%, 80%, 90%, 95%, or 99%, or about 100% of the R groups of the polymer are removed or separated from the polymer.

The present invention provides for new functional conductive polymers and their application in the electrode fabrication and post processing of the electrode to achieve high energy density, long cycling life, long calendar life and improved safety.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1. The first generic structure of the polymers and their transformation when thermal treated at high temperature to lose the side chains R₁ and R₂.

FIG. 2. Possible molecular A segments and (A)ₙ segments of the lithium-ion first generic structure of the polymers.

FIG. 3. Possible molecular E and F segments of the lithium-ion first generic structure of the polymers.

FIG. 4. Example of PFM, the first generic structure of the polymers, chemical transformation during thermal treatment at 500° C. The PFM and Si can be processed into a polymer composite electrode, the pyrolysis at 500° C. transformed the PFM polymer in the electrode.

FIG. 5. The second generic structure of the polymers and examples.

FIG. 6. Possible molecular structures of the 2nd generic structure.

FIG. 7. An example of second generic structure of the polymers and their transformation when thermal treated at high temperature to loss the side chains. The substituted polyaniline with octyl side chains are synthesized through PANI react with alkylbromide. The pyrolysis of the substituted PANI gives back PANI and loses the octyl side chains to create nano pores or molecular pores in PANI for lithium-ion transport. The substituted PANI is used as binder with Si based particles and other components to form Si electrode. Thermal treatment forms nano-porous surface coating on Si particles to facilitate ion transport as well as provide Si surface stabilization.

FIG. 8. Another example of second generic structure of the polymers and their transformation when pyrolyzed at high temperature to loss the side chains. The substituted polythiophene with hexyl side chains can be synthesized through co-polymerization of the two monomers. The thermal treatment of the substituted polythiophene produce polythiophene and losses the hexyl side chains to create nano pores or molecular pores for lithium-ion transport. The substituted polythiophene is used as binder with Si based particles and other components to form Si electrode. Thermal treatment form nano-porous surface coating on Si particles to facilitate ion transport as well as provide Si surface stabilization.

FIG. 9. PFM polymer thermal induced loss of dioctyl side chains and possible loss of carboxylate ester functional groups. DTA analysis of the structure transformation process indicated about 400-500° C. is the decomposition temperature of the pure PFM polymer. It lost about 39.7% weight during the pyrolysis process in the inert Ar atmosphere. The dioctyl chains account for total of about 42% weight. Considering the sp3 bond and aryl side chains are the most vulnerable components on the aromatic structure, the loss of dioctyle side chains are most likely event in this case.

FIG. 10. The FTIR spectra support the losing of dioctyl side chains as the strong alkyl C—H stretching is gone in the thermal treated film sample. The disappearing of ester functionality may also indicate the partial removal of the carboxylate ester. The aryl components clearly remain in the pyrolyzed sample. The elimination of Tg of the PFM after thermal treatment also supports the removal of the dioctyl side chains. (A) FTIR spectra of the PFM films of 80° C. drying, and after 500° C. heating in the inert atmosphere. (B) DSC of the PFM films of 80° C. drying, and after 500° C. heating in the inert atmosphere.

FIG. 11. Different applications of the PFM polymers in lithium battery field.

FIG. 12. Examples of PFM coated electrode for lithium metal battery.

FIG. 13. The morphology of 80° C. dried PFM film on Cu surface and 500° C. pyrolyzed PFM film surface.

FIG. 14. The PFM electrode binder forms very uniform coating on the surface of both active materials and acetylene black. After 500° C. pyrolysis, the transformed PFM electrode has similar morphology as the none thermal treated samples.

FIG. 15. The cell testing was performed in a PFM/SiOx/graphite electrode against lithium metal counter electrode coin cell. The 500° C. processed electrode shows superb electrode cycling stability and excellent coulombic efficiency.

FIG. 16. The cell testing was performed in a PFM/graphite electrode against lithium metal counter electrode coin cell. The 500° C. processed electrode shows superb electrode cycling stability and excellent coulombic efficiency.

FIG. 17. SEM electrode surface images for PFM, SiOx, Graphite, Denka black electrode dried at 80° C. and thermal treatment at 500° C. The PFM electrode binder forms very uniform coating on the surface of both active materials and acetylene black. After 500° C. thermal treatment, the transformed PFM electrode has similar morphology as the non thermal treated samples.

FIG. 18. PFM based SiOx electrode thermal transformation. TGA analysis of the PFM and SiOx composite electrode; heating rate at 20° C./min under Ar. PFM (15 wt. %). SiO (Shinetsu. 60 wt. %), graphite (Hitachi, 20 wt. %) and Denka black (5 wt. %,). Polymer thermal induced loss of dioctyl side chains and possible loss of carbyoxylate ester functional groups. DTA analysis of 400-500° C. is the transformation temperature of the PFM polymer.

FIG. 19. Cycling performance for PFM, SiOx, Denka black electrode dried at 80° C. and thermal treated at 500° C. Electrode composition: SiO (60 wt. %), graphite (20 wt. %), binder (15 wt. %), Denka black (5 wt. %). The cell testing was performed in a PFM/SiOx/graphite electrode against lithium metal counter electrode coin cell. The 500° C. processed electrode shows superb electrode cycling stability and excellent coulombic efficiency.

FIG. 20. Cycling performance for PFM, SiOx, graphite, Denka black electrode dried at 80° C. and thermal treated at 500° C. PFM-80: 1.43 mg/cm2 graphite: PFM-500: 1.64 mg/cm2 graphite. Electrolytes: Gen 2 EM/EMC=3:7, no FEC. Green: 5% FEC (500° C.). PFM-80: SOC thermal treated, PFM-500: 500C thermal treated electrode. The cell testing was performed in a PFM/SiOx/graphite electrode against lithium metal counter electrode coin cell. The 500° C. processed electrode shows superb electrode cycling stability and excellent coulombic efficiency. The table shows columbic efficiency of SiO/C elecrodes with PFM binders.

FIG. 21. Full testing results for PFM, SiOx and graphite, Denka black electrode dried at 80° C. and thermal treated at 500° C. and coupled with LPF electrode. Cathode LFP (2.66 mAh/cm²), Anode SiO/C with PFM-500 binder (1.50 mg/cm² active material, 2.45 mAh/cm²). Electrolytes: Gen 2 with 5% FEC. Capacity calculated based on anode loading. The cell testing was performed in a PFM/graphite electrode against lithium metal counter electrode coin cell. The 500° C. processed electrode shows superb electrode cycling stability and excellent coulombic efficiency. The table shows columbic efficiency of full cell of SiO/C anode with PFM binders (5% FEC).

FIG. 22. Cycling performance for PFM, Si, graphite, Denka black electrode dried at 80° C. and thermal treated at 500° C. PFM Si (4 micron diameter pure Si particle from Aldrich). The cell testing was performed in a PFM/graphite electrode against lithium metal counter electrode coin cell. The 500° C. processed electrode shows superb electrode cycling stability and excellent coulombic efficiency. The table shows columbic efficiency of Si (Micron) electrodes with PFM binders and Gen 2 electrolyte.

FIG. 23. Cycling performance for PFM, Si, graphite, Denka black electrode dried at 80° C. and thermal treated at 500° C. PFM Si (4 micron diameter pure Si particle from Aldrich). The cell testing was performed in a PFM/graphite electrode against lithium metal counter electrode coin cell. The 500° C. processed electrode shows superb electrode cycling stability and excellent coulombic efficiency. The table shows columbic efficiency of Si (Micron) electrodes with PFM binders, Gen 2 electrolyte with 5% FEC.

FIG. 24. Cycling performance for PFM, graphite, Denka black electrode dried at 80° C. and thermal treated at 500° C. PFM-80, the graphite electrode dried at 80° C. PFM-500, the graphite electrode processed at 500° C. Electrode composition: graphite (80 wt. %), binder (15 wt. %), Denka black (5 wt. %). The cell testing was performed in a PFM/graphite electrode against lithium metal counter electrode coin cell. The 500° C. processed electrode shows superb electrode cycling stability and excellent coulombic efficiency. The table shows columbic efficiency.

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only, and is not intended to be limiting.

In this specification and in the claims that follow, reference will be made to a number of terms that shall be defined to have the following meanings:

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The term “about” when applied to a value, describes a value that includes up to 10% more than the value described, and up to 10% less than the value described.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

The term “polymer” can also include the “conductive polymer” of the present invention.

The present invention provides for new materials structures and substantial improvements, described herein. In some embodiments, the structures are based on functional conductive polymer binders described in U.S. Pat. Nos. 8,852,461; 9,077,039; 9,153,353; 9,722,252; 9,653,734; 10,170,765; and 10,246,781; and U.S. Patent Application Publication No. 2015/0364755 (which are hereby incorporated by reference). In some embodiments, the invention allows commercial Si based materials to function properly in a commercial cell conditions, and addresses the most critical problems of both electrode mechanical degradation and electrode surface reactions of the Si materials.

The present invention provides for a class of conductive polymer materials with side chain structures described herein suitable as electrode binders for Si, Sn and other alloy based composite electrodes. It also functions with carbon and graphite based materials. This class of functional conductive polymer materials provides strong adhesion to the Si, Sn and carbon materials and Cu current collectors as an effective electrode binder. Thermal treatment of the polymer materials leads to the loss of the side chains to provide permanent and superb pathways ranging from Angstroms to Nanometers in the polymer films for lithium ion transport. When the polymers are applied on surface of Si or graphite, the polymers in touch with the active materials (Si, Sn and Carbon) surface transforms into passivation layer during the electrochemical process to provide very strong passivation to the active materials surface. The ion pathway in the polymer binder due to the thermal decomposition of side chains provides ion transport. In some embodiments, this functional binder is used to cover the entire active materials particles surface to provide both strong adhesion and surface protection. The results based on a 500° C. thermal treated Si composite electrode are excellent both in capacity retention and coulombic efficiency. In some embodiments, this class of electrode binders works for the anode for Na ion battery.

The same principle of electrode passivation and ion transport of this polymer can also be applied to lithium metal electrode protection as shown in figure herein. In this case, the functional polymers are used to protect the electrochemically deposited lithium metal against electrolyte and prevent both electrode and electrolyte side reaction and lithium dendrite formations.

Lithium ion and lithium metal battery companies and electric vehicle companies are most likely to use the invention. These companies can use this invention as one of the critical enabling materials and processes for their battery manufacturing process.

This class of functional conductive polymers has high electrochemical stability, excellent adhesion to the active material and electrode substrate and allows selective lithium ion transport to the active materials or collector substrate to ensure the overall integrity of the electrode system, and provide active material interface protection and passivation.

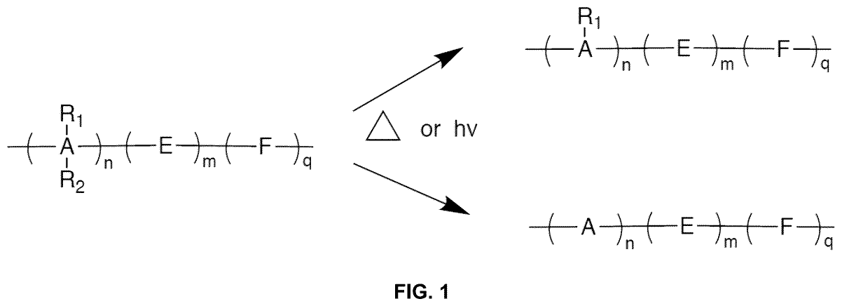

In some embodiments, the polymer comprises any of lithium-ion the following structure:

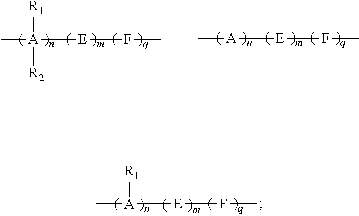

wherein each polymer chain can be terminated by H or other functional groups; N+m+q=1, and representing the relative abundance in the polymer chain; n, m, and q can be any number between 0-1; R1 and R2 are each independently an alkyl chain or oligo ethyleoxide chain or alkyloxide chain of any length between about 1-10000 carbon atoms, R1 and R2 can be hydroxide terminated or carboxylic acid or carboxylate salt terminated. See FIG. 1. In some embodiments, the heating or light process leads to partial or complete loss of R1 and R2 in any composition in the end form.

In some embodiments, the temperature can range from about 100 C to 1000 C. In some embodiments, the thermal treatment or light process can be oxygen free or have a controlled amount of oxygen. In some embodiments, this is a random copolymer or block polymer.

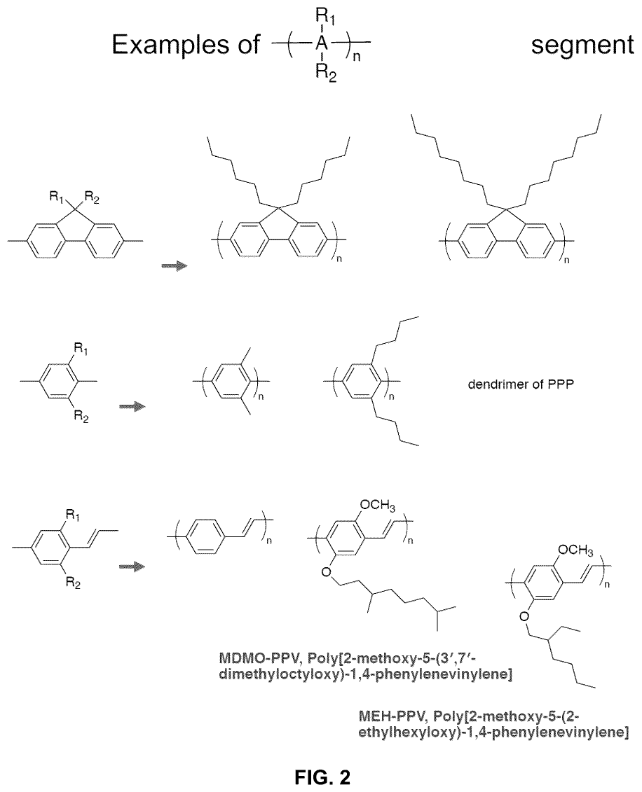

In some embodiments, molecular A segments and (A)ₙ segments of the first generic structure of the polymers are any of the structures shown in FIG. 2.

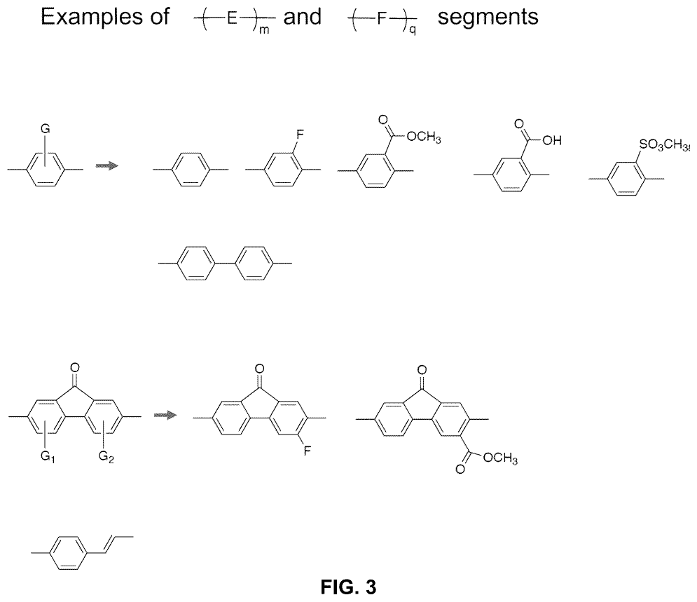

In some embodiments, molecular E segments and F segments of the first generic structure of the polymers are any of the structures shown in FIG. 3.

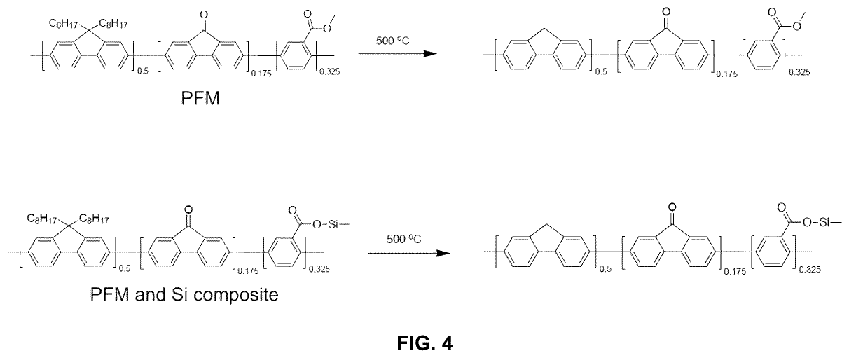

In some embodiments, PFM and Si composite electrode Pt generic structure process and usages are shown in FIG. 4.

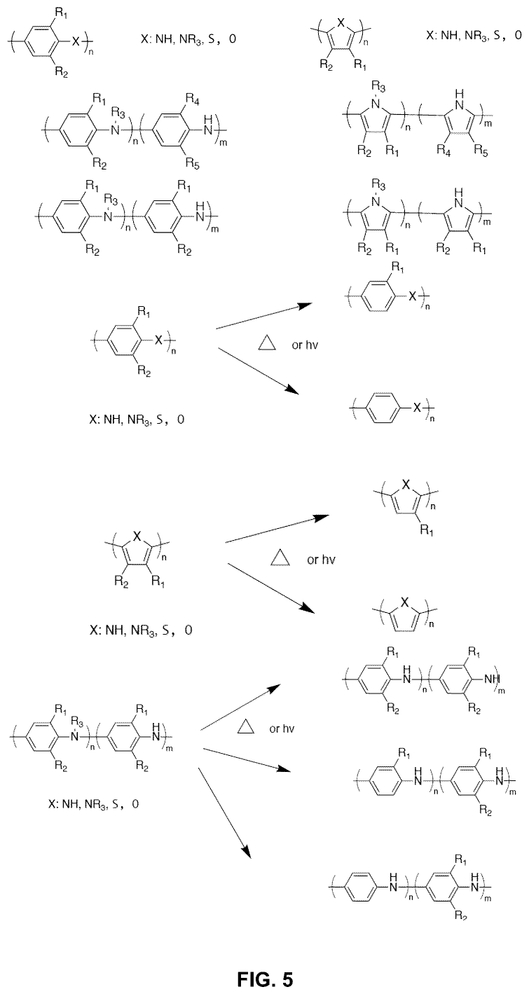

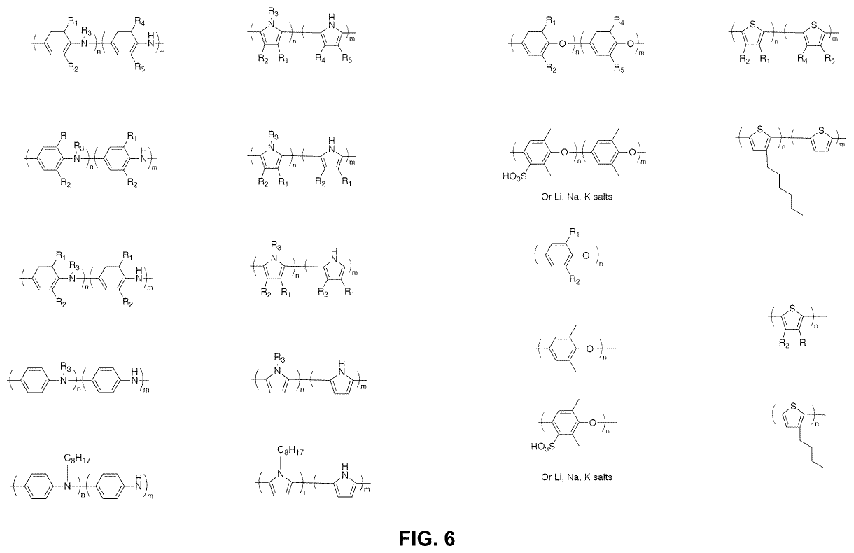

In some embodiments, the polymer (or second generic structure) comprises any one of the structures shown in FIGS. 5 and 6; wherein each polymer chains can be terminated by H or other functional groups; n indicates it is a polymer, n is between 1 and 100M Dalton; R1 and R2 are each independently an alkyl chain or oligo ethyleoxide chain or alkyloxide chain of any length between 1-10000 carbon atoms, and R1 and R2 can be hydroxide terminated or carboxylic acid or carboxylate salt terminated. In some embodiments, the heating or light process leads to partial or complete loss of R1, R2, R3 in any composition in the end form.

In some embodiments, the temperature can range from about 100 C to 1000 C. In some embodiments, the thermal treatment or light process can be oxygen free or have a controlled amount of oxygen. In some embodiments, this is a random copolymer or block polymer.

In some embodiments, the polymer comprises the following structure:

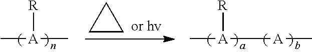

Chains may terminate with H.

n=a+b
a is between zero and n, and including zero and n.
The product is a random copo!yrner or block copolymer.
R is an alkyl chain or oligo ethyleoxide chain or alkyloxide chain of any length between 1-10000 carbon atoms, R can be hydroxide terminated or carboxylic acid or carboxylate salt terminated.

In some embodiments, the main chain with repeating unit of A forms a fully conjugated polymer backbone. Thermal or optical treatment leads to full or partial loss of its side chain R, while preserving the main polymer backbone structures. This process provides a unique ion transport properties in the treated polymer film. Depending on the applications, for lithium ion anode applications, n-type of backbone structure is preferred such as below:

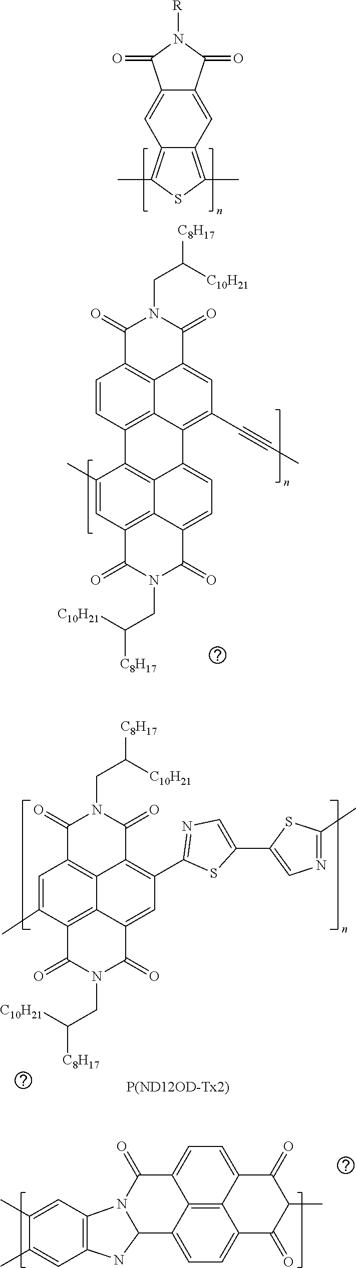

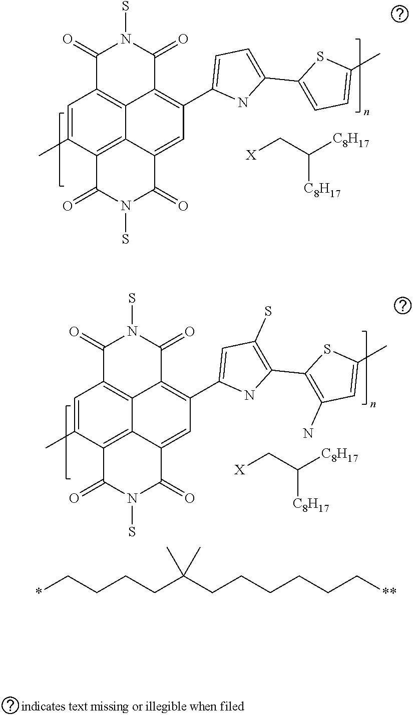

Side chains substituted PPV
Side chains substituted polyfluorene
Side chains substituted polyphenylene
   which is the third generic structure of the conjugated polymers and examples.

In some embodiments, the polymer comprises any of the following structures:

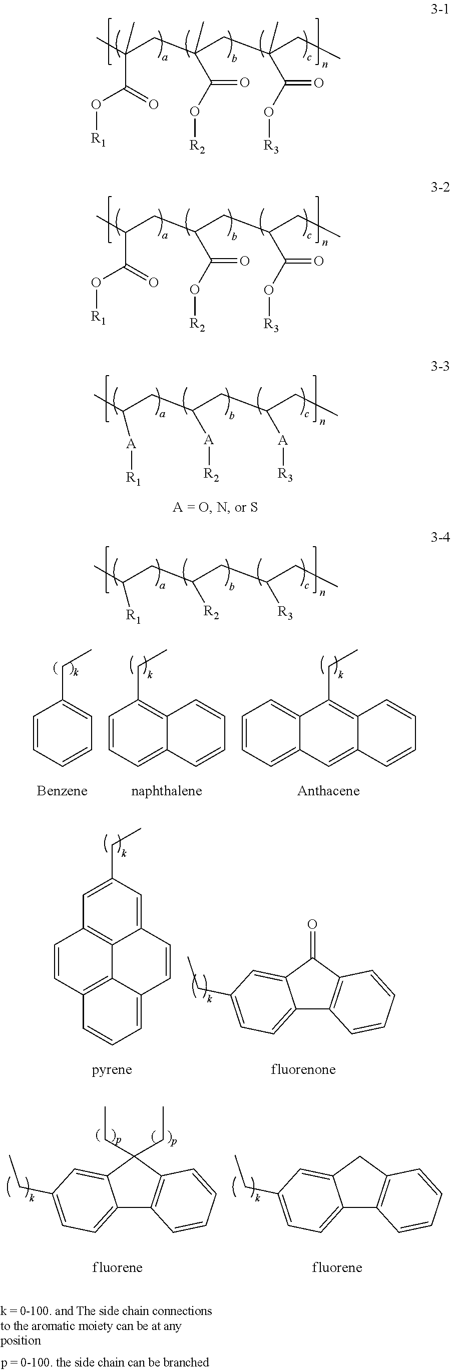

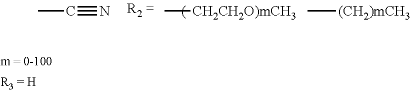

This is a random copolymer or block copolymer. a, b, c indicate the ratio of the 3 moieties. a+b+c=1, and a,b,c can be any number between 0-1 including 0 and 1,

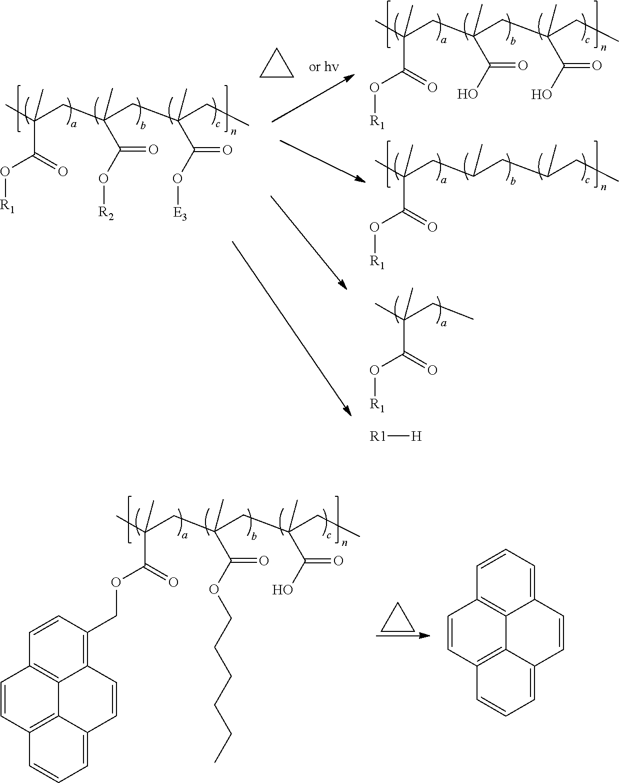

which is the forth generic structure of the polymers and examples, which are side chained functional polymers.

In some embodiments, the following is a detailed example PFM and Si composite electrode 1st generic structure process and usages, as well as battery testing data.

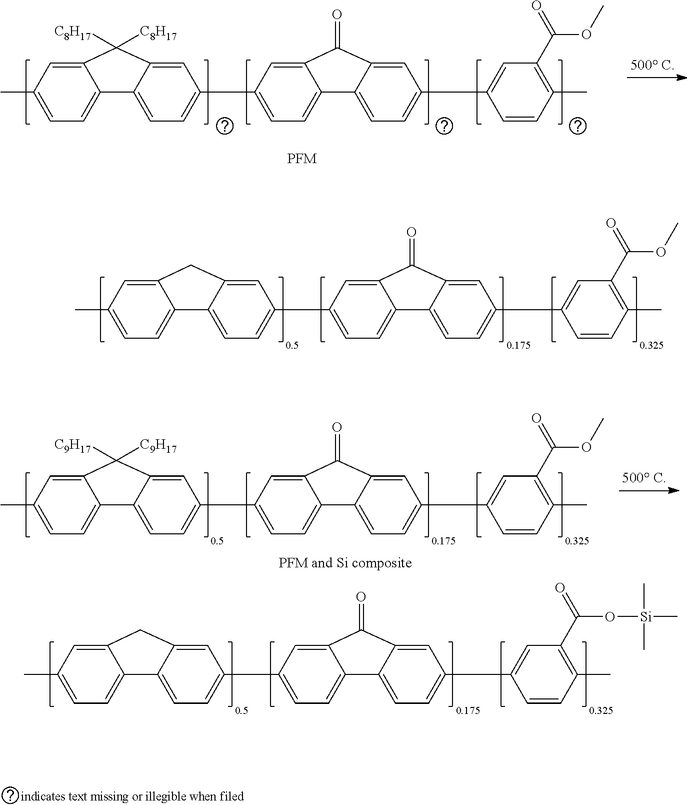

In this case, the thermal treatment is oxygen free. However, oxygen (partially or entirely) can be used to adjust the treatment process.

In some embodiments, the polymers can be used as follows:
1. The polymer can be dissolved in a solvent or solvents and mixed with active materials particles and other additive particles to form a slurry. The slurry can be coated on the surface of a current collector and dried into a composite laminate film. The film then be thermal treated to transform into the final form.
2. The polymers can be dissolved in a selected solvent and coated on to the active materials surface and dried and thermal treated at the selected temperature to transform into the final form to form the coating and protective layer. The coated particles can be used as battery materials.
3. The polymer can be directly coated on a flat surface such as carbon, Si, Al, Li, Sn film surface and be thermal treated to transform into the final form.
4. The usages can be for lithium battery, sodium battery, Mg and Zn battery system.
5. The usages are not limited to battery application, but can be used to any applications need to have ion or electron mobility.

PFM Usage in Electrode Making and Processing and Electrochemical Cell Fabrication.

Composite electrode formulation, electrode casting and post treatment. SiO/C electrodes: 15 wt. % of PFM binder was dissolved in specific amount of chlorobenzene to form a homogeneous and vicious solution. Then, SiO/C (Shinetsu, 60 wt. %), graphite (Hitachi, 20 wt. %) and Denka black (5 wt. %) were sequentially added and thoroughly ground for 30 mins under room temperature. The slurry was coated on a copper foil by using a doctor blade (˜200 μm), and the coated electrode was then dried in the vacuum oven for 12 h at 80° C. The mass loading of active material (SiO/C) is 1.52±0.12 mg/cm2. The electrodes with the PFM binder were heated to a certain temperature (e.g., 500° C. for 15 mins with a ramp rate of 5° C./min) in a tube furnace under ultrapure argon flow to obtain the final electrodes. Experimentally, a mass retention of ˜95% for the SiO/C electrodes (˜97% for the graphite electrodes) was observed due to thermal decomposition of the PFM binder.

Cell fabrication. Coin cells (CR2032, MTI Corp.) were assembled in an argon-filled glovebox. Celgard 2400 was used as the separator. Lithium-ion electrolyte (Gen 2) was obtained from the Argonne National Lab, containing 1.2M LiPF6 in ethylene carbonate, diethyl carbonate (EC/DEC=3/7 w/w) without other additives. The PFM based Si electrode is coupled with Li metal counter electrode to fabricate testing cells. The PFM based Si electrode is also coupled with LiFePO4 cathode to fabricate lithium ion cells.

Lithium metal electrode or anode-less electrode fabrication. The PFM chlorobenzene solution is coated either on Cu current collector or on Al on Cu or on Li directly. The PFM coated Cu electrode was heated to a certain temperature (e.g., 500° C. for 15 mins with a ramp rate of 5° C./min) in a tube furnace under ultrapure argon flow to obtain the final PFM coated Cu electrodes or PFM coated Al/Cu electrodes, or PFM coated Li electrode.

Cell fabrication. Coin cells (CR2032, MTI Corp.) were assembled in an argon-filled glovebox. Celgard 2400 was used as the separator. Lithium-ion electrolyte (Gen 2) was obtained from the Argonne National Lab, containing 1.2M LiPF6 in ethylene carbonate, diethyl carbonate (EC/DEC=3/7 w/w) without other additives. The PFM coated Cu or PFM coated Al/Cu or PFM coated Li metal electrode is coupled with Li metal counter electrode to fabricate testing cells. The PFM coated Cu or PFM coated Al/Cu or PFM coated Li metal electrode Si electrode is also coupled with LiFePO4 cathode to fabricate lithium metal full cells.

Functional Conductive Polymers and Electrode Processing for Lithium Battery Applications.

(1) PFM electrode SiO and graphite alone electrode fabrication procedures, and the electrode composition, final loading.

SiO/C electrodes: 15 wt. % of PFM binder was dissolved in specific amount of chlorobenzene to form a homogeneous and vicious solution. Then, SiO/C (Shinetsu, 60 wt. %), graphite (Hitachi, 20 wt. %) and Denka black (5 wt. %) were sequentially added and thoroughly ground for 30 mins under room temperature. The slurry was coated on a copper foil by using a doctor blade (˜200 μm), and the coated electrode was then dried in the vacuum oven for 12 h at 80° C. The mass loading of active material (SiO/C) is 1.52±0.12 mg/cm².

Graphite electrodes: 7 wt. % of PFM binder was dissolved in specific amount of chlorobenzene to form a homogeneous and vicious solution. Then, graphite (Hitachi, 90 wt. %) and Denka black (3 wt. %) were sequentially added and thoroughly ground for 30 mins under room temperature. The slurry was coated on a copper foil by using a doctor blade (˜200 μm), and the coated electrode was then dried in the vacuum oven for 12 h at 80° C. The mass loading of active material (graphite) is 3.60±0.35 mg/cm².

Binder electrodes: 70 wt. % of PFM binder was dissolved in specific amount of chlorobenzene to form a homogeneous and vicious solution. Then, Denka black (30 wt. %) was added and thoroughly ground for 30 mins under room temperature. The slurry was coated on a copper foil by using a doctor blade (˜200 μm), and the coated electrode was then dried in the vacuum oven for 12 h at 80° C. The mass loading of PFM binder is 0.77±0.09 mg/cm².

Coin cells (CR2032, MTI Corp.) were assembled in an argon-filled glovebox. Celgard 2400 was used as the separator. Lithium-ion electrolyte (Gen 2) was obtained from the Argonne National Lab, containing 1.2M LiPF₆ in ethylene carbonate, diethyl carbonate (EC/DEC=3/7 w/w) without other addictive.

(2) Heat treatment process of the electrode.

The SiO/C (or graphite) electrodes with the PFM binder were heated to a certain temperature (e.g., 500° C. for 15 mins with a ramp rate of 5° C./min) in a tube furnace under ultrapure argon flow to obtain the final electrodes. Experimentally, a mass retention of ˜95% for the SiO/C electrodes (˜97% for the graphite electrodes) was observed due to thermal decomposition of the PFM binder.

(3) The electrode testing procedures.

Galvanostatic cycling (at C/10 rate) of the assembled coin cells between 1.0 V and 0.01V was executed on a Maccor Series 4000 Battery Test system (MACCOR Inc. Tulsa OK, USA) in a thermal chamber at 30° C. The C rate was determined based on the theoretical capacity upon a full lithiation of the active material (SiO/C or graphite). The theoretical capacity of 1200 mAh/g for SiO/C active material (372 mAh/g for Hitachi graphite) was used to calculate the current.

Cyclic voltammetry (CV) of binder electrodes between 10 mV and 1.0 V vs. Li/Li⁺ was executed on a VSP300 potentiostat (Biologic, Claix, France) with a constant voltage rate (10 mV/s) in a thermal chamber at 30° C.

(4) IR experimental procedures. SEM procedure.

Membrane Fabrication: Free-standing PFM films for structural characterization were prepared by polymer solution casting. Generally, PFM sample was dissolved in chlorobenzene with a concentration of 80 mg/mL and stirred for few hours at room temperature. The solution was then poured onto a clean glass slide and dried at room temperature for 12 h. Then, the film was dried in a vacuum oven at 80° C. for 12 h, cooled down to room temperature and peeled off from glass slide to obtain the free-standing films. The pristine PFM film has an orange color. PFM films after thermal decomposition was obtained by heating the films to a certain temperature (e.g., 500° C. for 15 mins with a ramp rate of 5° C./min) under ultrapure argon flow. The resulting films are free-standing and shows a dark grey color.

Fourier transform infrared spectrometry (FT-IR): The FT-IR spectra of PFM films (pristine and after heating) were recorded on Nicolet iS50 FTIR (ThermoFisher, Waltham MA, USA) with attenuated total reflectance (ATR) function.

Scanning electron microscopy (SEM): The surface images of composite electrodes (or binder films) on the copper foil were collected with JSM-7500F SEM (JOEL Ltd., Tokyo, Japan) with an accelerating voltage of 12 kV under high vacuum at room temperature. The samples were thoroughly dried under vacuum before the morphology measurement.

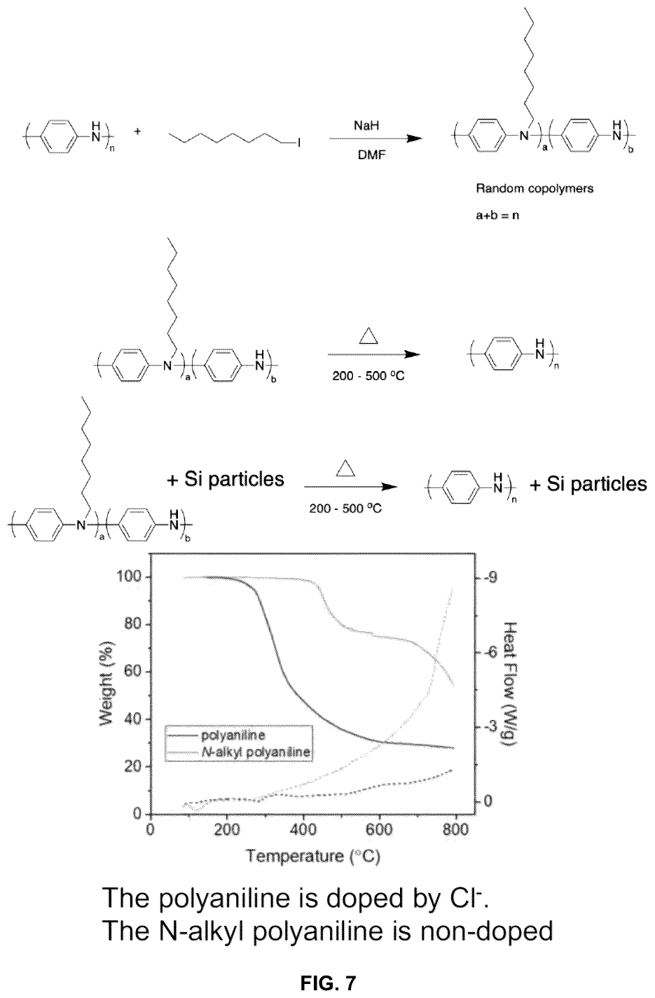

Synthesis of N-alkyl polyaniline: Commercial doped polyaniline (Honeywell Fluka, 200 mg) was dissolved in 20 mL dry tetrahydrofuran (THF, Sigma-Aldrich) under nitrogen atmosphere. Then, sodium hydride (NaH, 172 mg, 60% dispersion mineral oil, Sigma-Aldrich) was slowly added to the reaction solution at 0° C. The mixture was stirred for 1 hour in an ice bath to allow the deprotonation of polyaniline. A 10 vol % solution of 1-iodooctane (1.44 g, Sigma-Aldrich) in THF was then added and the solution was stirred for 12 h under room temperature. The final polymer product was obtained by evaporating the THF and thoroughly washed with acetone and methanol to remove any sodium salts and unreacted alkyl halide. The obtained dark-grey precipitate (232 mg) was dried under vacuum at 60° C. for 12 h to remove any remaining solvent. See FIG. 7.

In one example of modified PANI and Si composite electrode 2nd generic structure synthesis, process and usages: FIG. 7 shows an example of second generic structure of the polymers and their transformation when thermal treated at high temperature to loss the side chains. The substituted polyaniline with octyl side chains is synthesized through PANI react with alkylbromide. The pyrolysis of the substituted PANI gives back PANI and loses the octyl side chains to create nano pores or molecular pores in PANI for lithium-ion transport. The substituted PANI is used as binder with Si based particles and other components to form Si electrode. Thermal treatment forms nano-porous surface coating on Si particles to facilitate ion transport as well as provide Si surface stabilization.

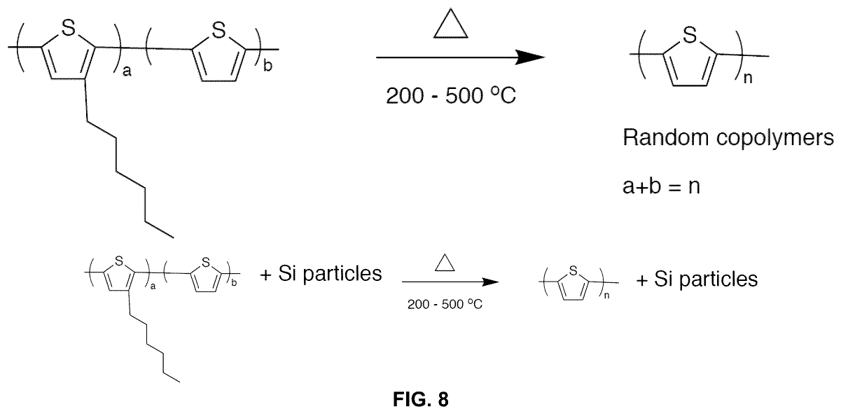

In another example of a modified polythiophene and Si composite electrode 2nd generic structure synthesis, process and usages: FIG. 8 shows another example of second generic structure of the polymers and their transformation when pyrolyzed at high temperature to loss the side chains. The substituted polythiophene with hexyl side chains can be synthesized through co-polymerization of the two monomers. The thermal treatment of the substituted polythiophene produce polythiophene and losses the hexyl side chains to create nano pores or molecular pores for lithium-ion transport. The substituted polythiophene is used as binder with Si based particles and other components to form Si electrode. Thermal treatment form nano-porous surface coating on Si particles to facilitate ion transport as well as provide Si surface stabilization.

The solubility of PFM is tested in different solvents. 5 mg PFM is mixed in ˜0.8 mL of different solvents. The results are: chloroform and toluene have good solubility; NMP has limited solubility; and DMSO is insoluble. NMP can be used as a solvent at ambient temperature or elevated temperature.

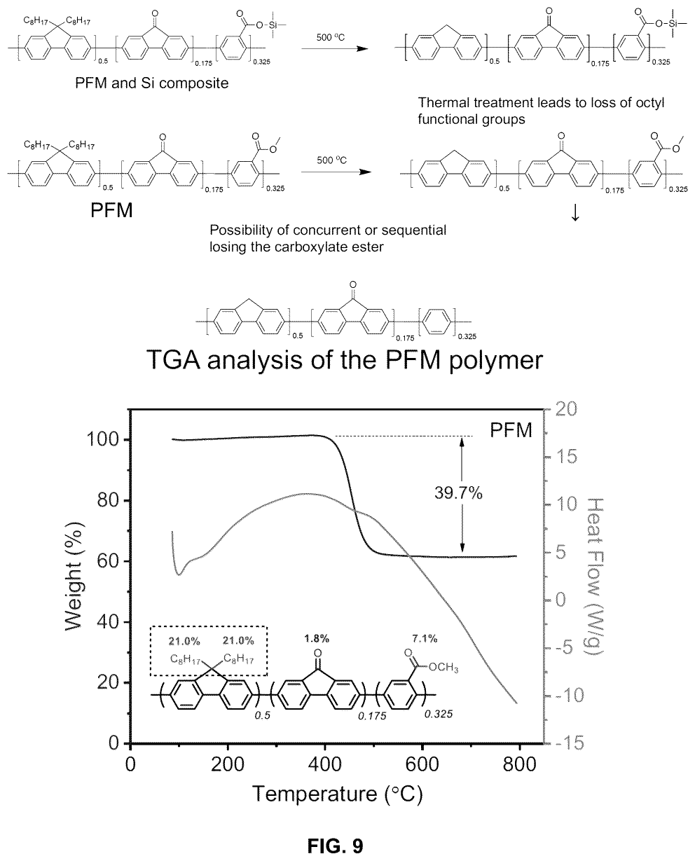

PFM Thermal Transformation. FIG. 9 shows the PFM polymer thermal induced loss of dioctyl side chains and possible loss of carboxylate ester functional groups. DTA analysis of the structure transformation process indicated 400-500° C. is the decomposition temperature of the pure PFM polymer. It lost 39.7% weight during the pyrolysis process in the inert Ar atmosphere. The dioctyl chains account for total of 42% weight. Considering the sp3 bond and aryl side chains are the most vulnerable components on the aromatic structure, the loss of dioctyle side chains are most likely event in this case.

PFM loses 39.7% of its own weight during heating, matched with two alkyl chains (C₈H₁₇, theoretical 42%). PFM-500 is prepared by heating PFM to 500° C. at a rate of 20° C./min. and hold at 500° C. for 15 min. under N₂. See FIG. 9.

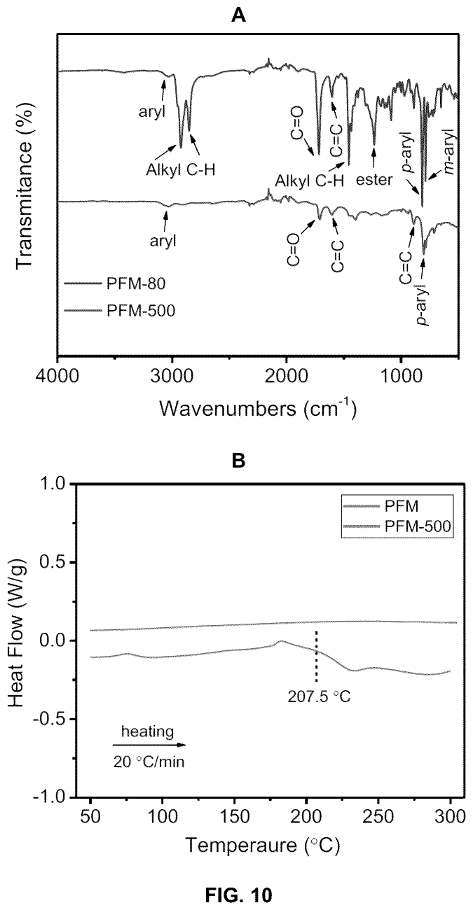

FIG. 10 shows the FTIR spectra support the losing of dioctyl side chains as the strong alkyl C—H stretching is gone in the thermal treated film sample. The disappearing of ester functionality may also indicate the partial removal of the carboxylate ester. The aryl components clearly remain in the pyrolyzed sample. The elimination of Tg of the PFM after thermal treatment also supports the removal of the dioctyl side chains.

The sole function of the dioctyl chains on the PFM backbone is for solubility in the solvents for processing. The FTIR spectra show the losing of dioctyl functional groups from the PFM after 500 oC heating in the inner atmosphere. DSC curves show the PFM glass transition temperature (Tg) at 207.5 oC. After heating at 500 oC, the Tg thermal transition at 207.5 oC disappears, and no thermal transitions are detected at between 50-300 oC. Thermal treatment leads to loss of the octyl functional groups creates sub nano-porosity or molecular gaps for lithium-ion transport through the PFM membrane.

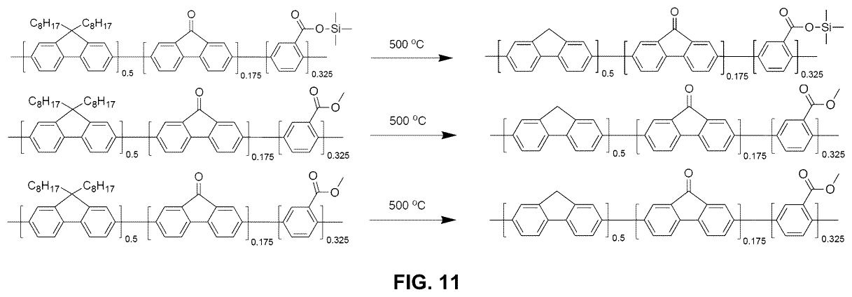

FIG. 11 shows the different applications of the PFM polymers in lithium battery field.
1. PFM and Si composite electrode: PFM binder and Si materials along with conductive additive acetylene black can form composite electrode for lithium-ion rechargeable battery negative electrode.
2. PFM/SiOx composite electrode: PFM binder and SiOx materials along with conductive additive acetylene black can form composite electrode for lithium-ion rechargeable battery negative electrode.
3. PFM/SiOx/carbon composite electrode: PFM binder, SiOx and graphite materials along with conductive additive acetylene black can form composite electrode for lithium-ion rechargeable battery negative electrode.

PFM and carbon (graphite) composite electrode: PFM binder and graphite materials along with conductive additive acetylene black can form composite electrode for lithium-ion rechargeable battery negative electrode.

PFM film on Cu electrode: PFM binder coated on the surface of a current collector such as Cu can be used as anode-less anode electrode for lithium metal rechargeable battery negative electrode. The PFM and treated PFM film protect the deposited Li metal.

Or PFM film on Li electrode: PFM binder coated on the surface of a Li metal can be used as anode electrode for lithium metal rechargeable battery negative electrode. The PFM and treated PFM film protect the deposited Li metal.

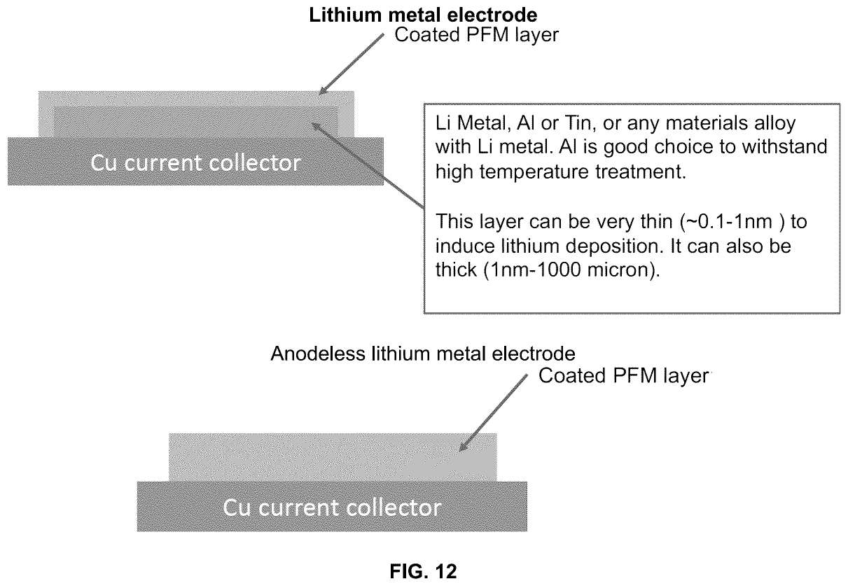

FIG. 12 shows examples of PFM coated electrode for lithium metal battery. In both cases, the PFM can range from 0.1 nm to 100 microns. The electrodes will go through thermal treatment at various temperature.

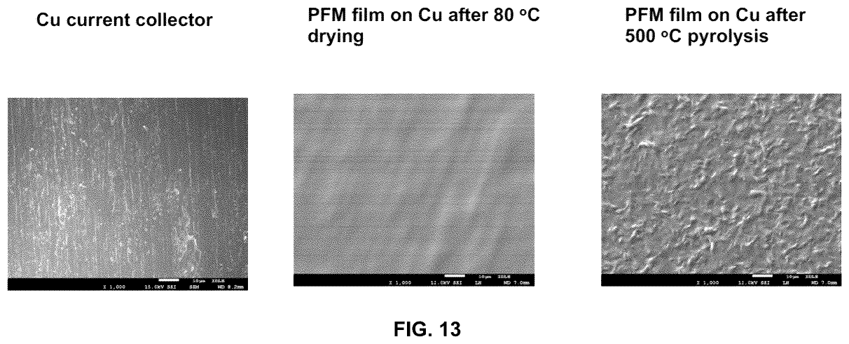

FIG. 13 shows the morphology of 80° C. dried PFM film on Cu surface and 500° C. pyrolyzed PFM film surface. PFM film on copper after 80° C. dry and thermal treatment at 500° C. SEM of the surface. The PFM polymer forms very uniform film on the surface of Cu. After 500° C. thermal treatment, the transformed PFM film appears to be wrinkled.

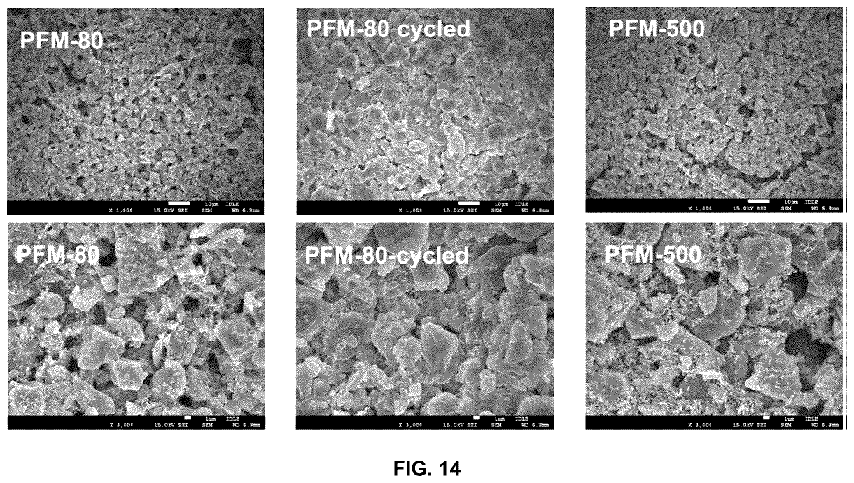

FIG. 14 shows the PFM electrode binder forms very uniform coating on the surface of both active materials and acetylene black. After 500 C pyrolysis, the transformed PFM electrode has similar morphology as the non thermal treated samples. PFM, SiOx, Denka black electrode dried at 80° C. and thermal treatment at 500° C. SEM electrode surface images.

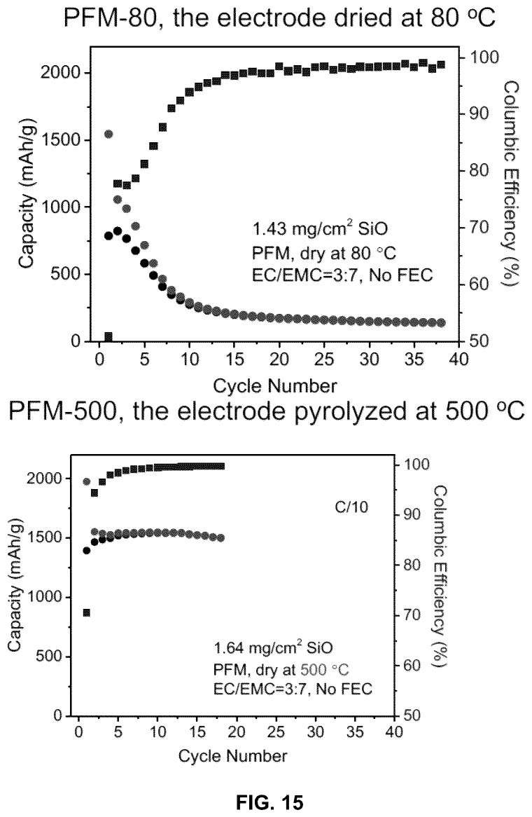

FIG. 15 shows the cell testing was performed in a PFM/SiOx/graphite electrode against lithium metal counter electrode coin cell. The 500° C. processed electrode shows superb electrode cycling stability and excellent coulombic efficiency. PFM, SiOx, Denka black electrode dried at 80° C. and thermal treated at 500° C. Cycling performance. Electrode composition: SiO (60 wt. %), graphite (20 wt. %), binder (15 wt. %), Denka black (5 wt. %). See Table 1.

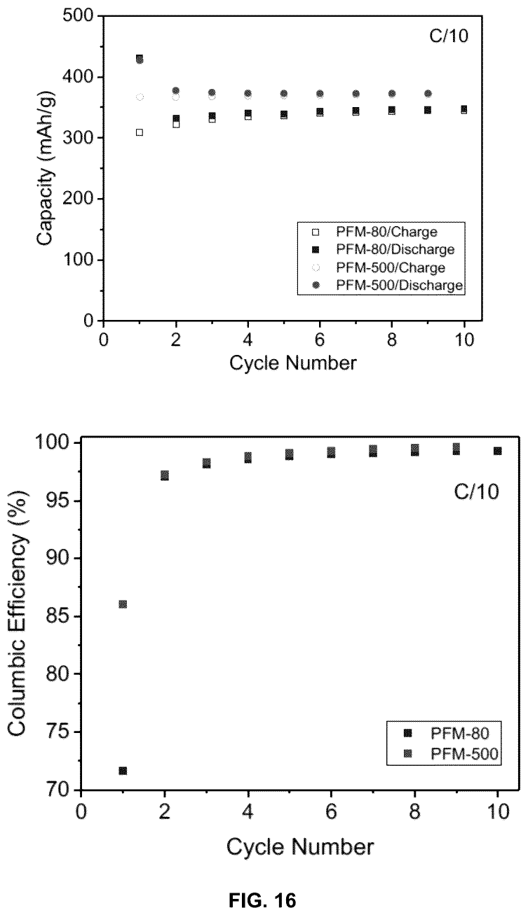

FIG. 16 shows the cell testing was performed in a PFM/graphite electrode against lithium metal counter electrode coin cell. The 500° C. processed electrode shows superb electrode cycling stability and excellent coulombic efficiency. PFM, graphite, Denka black electrode dried at 80° C. and thermal treated at 500° C. Cycling performance. Electrode composition: graphite (80 wt. %), binder (15 wt. %), Denka black (5 wt. %). See Table 2.

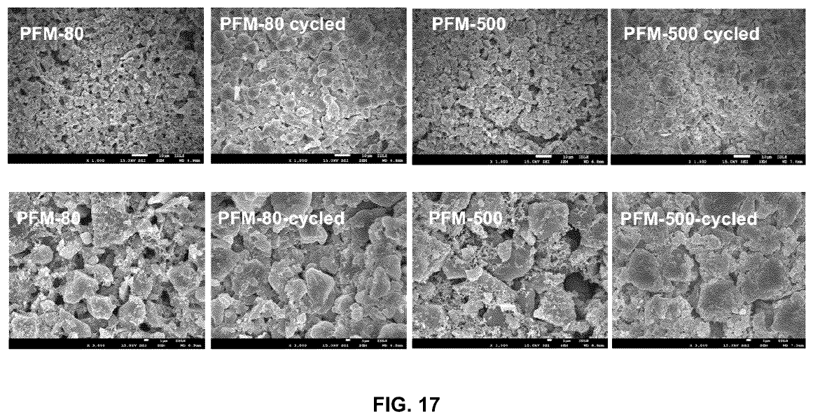

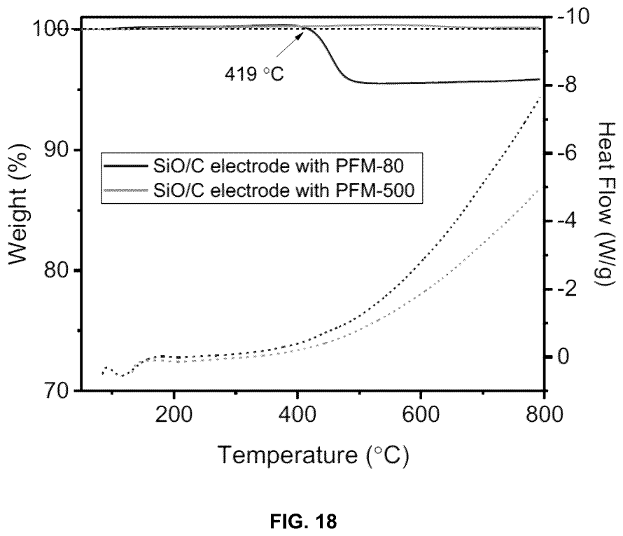

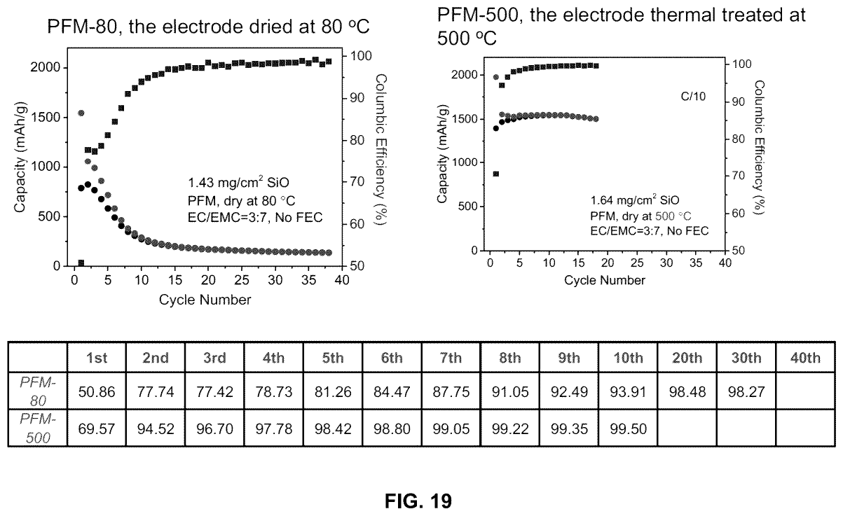

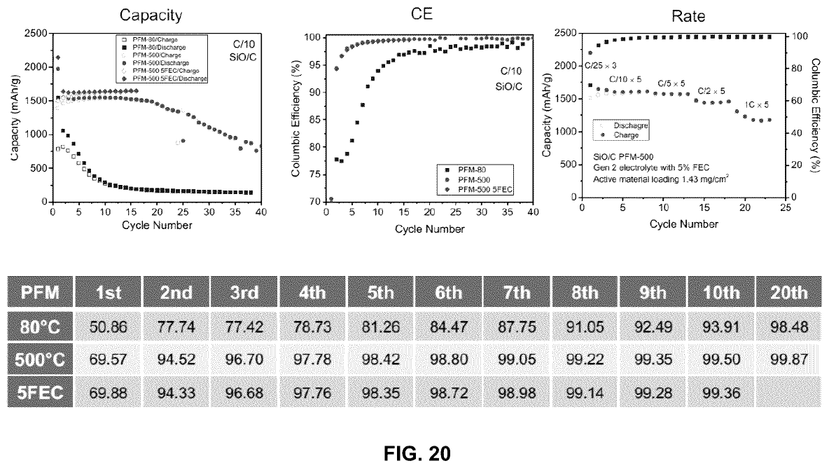

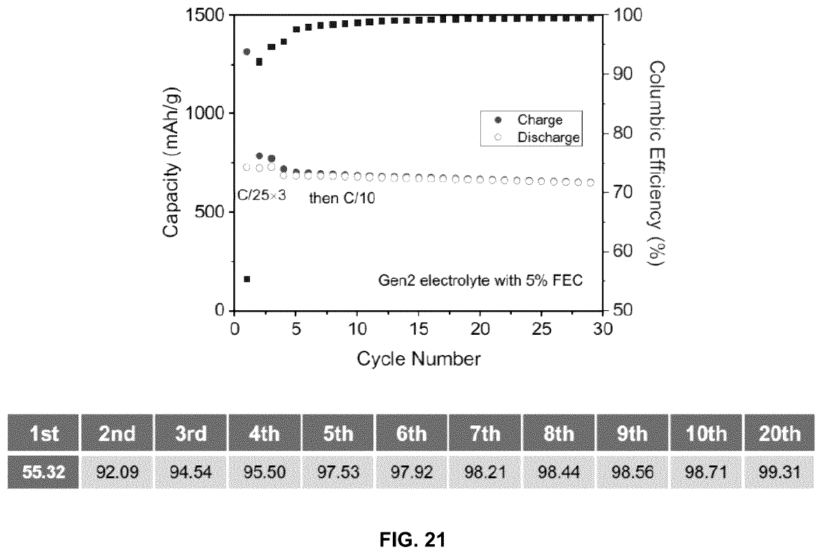

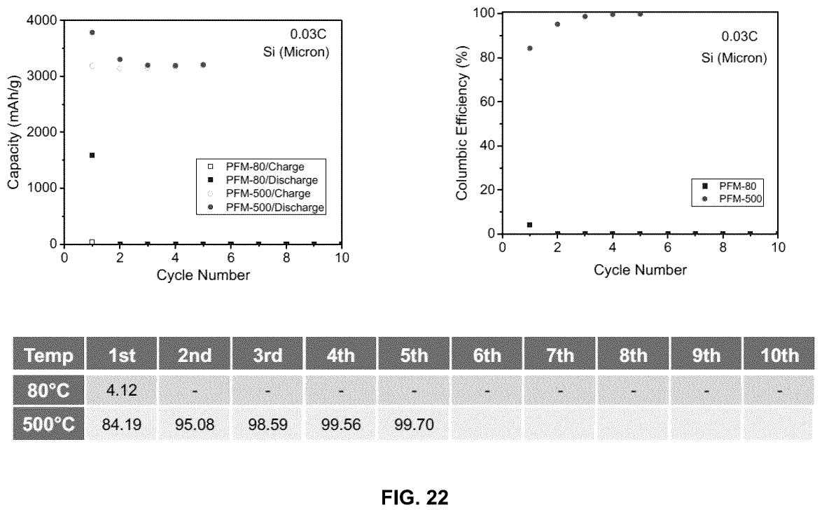

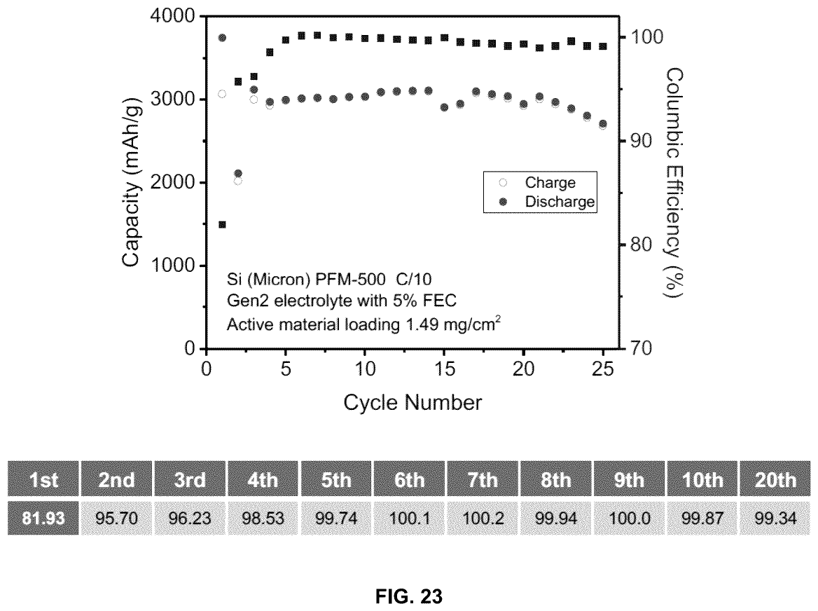

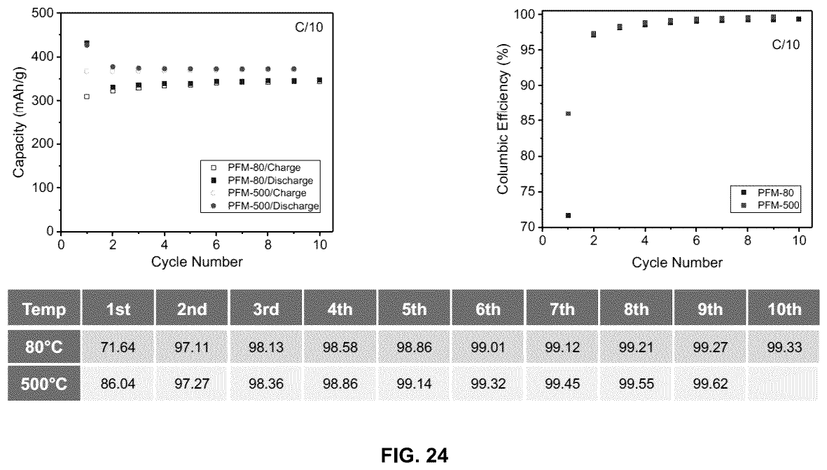

FIGS. 17-24 show additional results.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

TABLE 1

| | 1st | 2nd | 3rd | 4th | 5th | 6th | 7th | 8th | 9th | 10th | 20th | 30th | 40th |
|---|---|---|---|---|---|---|---|---|---|---|---|---|---|
| PFM-80 | 50.86 | 77.74 | 77.42 | 78.73 | 81.26 | 84.47 | 87.75 | 91.05 | 92.49 | 93.91 | 98.48 | 98.27 | |
| PFM-500 | 69.57 | 94.52 | 96.70 | 97.78 | 98.42 | 98.80 | 99.05 | 99.22 | 99.35 | 99.50 | | | |

TABLE 2

| Temp | 1st | 2nd | 3rd | 4th | 5th | 6th | 7th | 8th | 9th | 10th |
|---|---|---|---|---|---|---|---|---|---|---|
| 80° C. | 71.64 | 97.11 | 98.13 | 98.58 | 98.86 | 99.01 | 99.12 | 99.21 | 99.27 | 99.33 |
| 500° C. | 86.04 | 97.27 | 98.36 | 98.86 | 99.14 | 99.32 | 99.45 | 99.55 | 99.62 | |

What is claimed is:

1. A conductive polymer having repeating subunits defined by any unmodified polymer having any one of the following formulae: 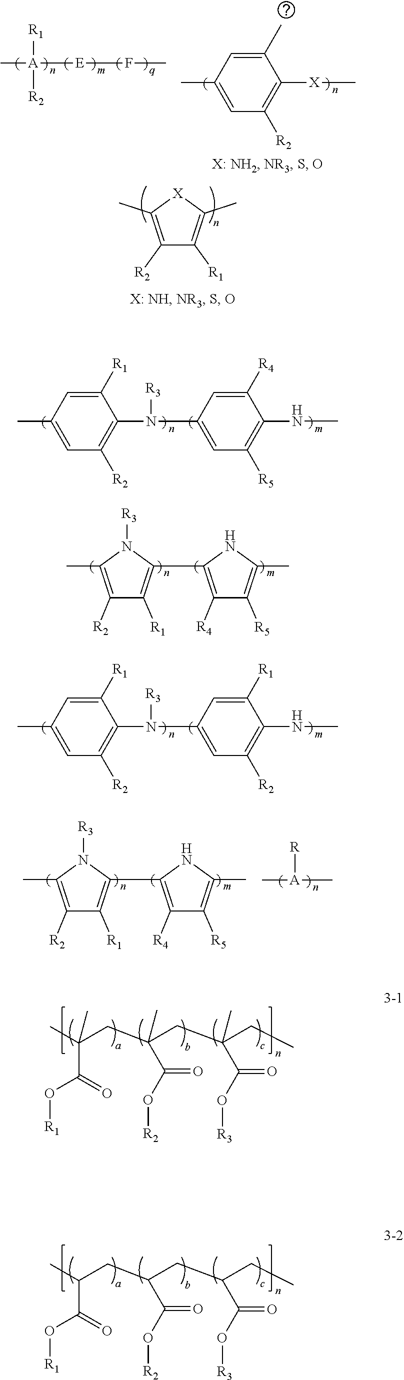 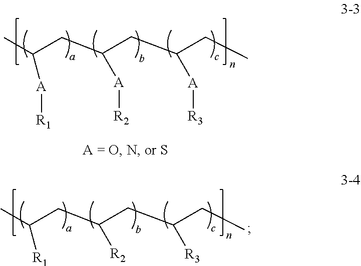
or any unmodified polymer wherein at least one R group, side chain, or alkyl or aryl side chain, of at least one subunit of the unmodified polymer is removed or separated from the unmodified polymer.

2. The conductive polymer of claim 1, wherein at least about 10%, 20%, 30%, 40%, 50%, 60%, 70%, 80%, or 90%, or about 100% of the R groups of the unmodified polymer are removed or separated from the polymer.

3. The conductive polymer of claim 1, wherein the R group, side chain, or alkyl or aryl side chain is removed or separated from the polymer by heating or exposure to light (hv).

4. A thin film electrode comprising a first layer comprising the conductive polymer of claim 1 on a second layer of current collector comprising an electricity conductive material.

5. The thin film electrode of claim 4, wherein the conductive material is a metal, such as silver, copper, gold, aluminum, iron, steel, brass, bronze, or mercury.

6. The thin film electrode of claim 4, wherein the conductive material is graphite.

7. The thin film electrode of claim 4, wherein the first layer and the second layer completely cover a third layer comprising Li metal, Al, Sn, or Mg, or any material alloy comprising Li metal or Na or Mg.

8. The thin film electrode of claim 7, wherein the third layer is very thin, such as from about 0.1 nm to about 1 nm.

9. The thin film electrode of claim 7, wherein the third layer is thick, such as from about 1 nm to about 1 mm.

10. A lithium ion battery having a negative electrode, wherein said electrode comprises a thin film electrode of claim 3.

11. A method for producing a conductive polymer, the method comprising: heating, or exposing to light (hv), an unmodified polymer such that at least one R group of at least one subunit of the unmodified polymer is removed or separated from the unmodified polymer resulting in the formation of a conductive polymer of claim 1.

12. The method of claim 11, wherein the heating step comprises heating the unmodified polymer to a temperature of about 200° C., 250° C., 300° C., 350° C., 400° C., 450° C., or 500° C., or a temperature between any two of the preceding values, such that at least one R group of at least one subunit of the unmodified polymer is removed or separated from the unmodified polymer.

13. The method of claim 11, wherein at least about 10%, 20%, 30%, 40%, 50%, 60%, 70%, 80%, or 90%, or about 100% of the R groups of the unmodified polymer are removed or separated from the unmodified polymer.
